(19) United States
(12) Patent Application Publication
(10) Pub. No.: US 2006/0241985 A1
(43) Pub. Date: Oct. 26, 2006

(54) System and methods for transportation utilization and control

(75) Inventors: W. Craig Arnold, Parkersburg, WV (US); Carl Jason Bullock, Vienna, WV (US)

Correspondence Address: CAHN & SAMUELS LLP, 2000 P STREET NW, SUITE 200, WASHINGTON, DC, 20036, US

(73) Assignee: Greenpak, Inc., Parkersburg, WV (US)

(21) Appl. No.: 11/314,193

(22) Filed: Dec. 22, 2005

Related U.S. Application Data
(60) Provisional application No. 60/637,758, filed on Dec. 22, 2004.

(51) Int. Cl. G01C 21/34

(52) U.S. Cl. 705/6

(57) ABSTRACT

A complete logistics and transportation management system, with a number of integrated software and hardware components integrated to provide a total system for scheduling transportation assets and all deliveries of outbound products, and all inbound returns of products for repair and remediation. Collection of data throughout the system at various times enables efficient scheduling and assignment of shipments.

### CROSS REFERENCE TO RELATED APPLICATIONS

This application is an application filed under 35 U.S.C. § 111(a) claiming benefit pursuant to 35 U.S.C. § 119(e)(1) of Provisional Application Serial No. 60/637,758 filed on Dec. 22, 2004, which was filed pursuant to 35 U.S.C. § 111(b), the entire contents of which are incorporated herein by reference.

### FIELD OF THE INVENTION

This invention relates generally to a system and method for the efficient warehousing, pickup, shipment and delivery of goods. More particularly, the invention relates to a system in which goods are tracked throughout an entire cycle of product creation and delivery and the system includes the generation of efficient shipment scheduling and routing protocols utilizing both inside and outside shippers and further includes efficient return and reuse of product shipping containers and/or support equipment.

### BACKGROUND OF THE INVENTION

Tracking of containers in transit is well developed, including the use of satellites and other electronic technology to obtain real-time data on in transit locations. Inventory accounting and management is also a well developed field in which the contents of very large warehouses are ascertainable with a high degree of detail at any point in time. An area which has been somewhat neglected, however, is the area of efficient scheduling and routing of deliverable products and their associated containers or support equipment.

Another critical area which is not addressed at all by most logistics systems is that of racks which support product within a container. In many respects, these racks, their location, expected time of arrival on return, and condition, are just as critical and valuable as the products they carry. For without racks, many products cannot be shipped. There is thus a need to track shipping racks, particularly on the return trip to suppliers, as closely as the shipment of product.

### SUMMARY OF THE INVENTION

Illustrative, non-limiting embodiments of the present invention overcome the aforementioned and other disadvantages associated with related art shipping and tracking systems.

It is an aspect of the present invention to provide a complete logistics and transportation management system, with a number of integrated software and hardware components integrated to provide a total system for scheduling transportation assets and all deliveries of outbound products, and all inbound returns of products for repair and remediation.

More particularly, an inventory scheduling and tracking system in accordance with the present invention is used to monitor, track and report on any number of processes, including manufacturing, repairs, quality control, testing, and storage. The system according to the invention is also very flexible in that it is very easily customizable to capture information or track processes of many different types.

Mobile data collection units are used as automatic near real-time windows into the system. The data collection units have a built-in imaging engine and bar codes of both one and two dimensions can be read at any time with respect to goods within the system. Information may also be manually entered using an alpha-numeric keyboard, on-screen letter recognition tools or screen keyboard, for example, Windows Mobile compatible handhelds, or via direct entry through a rugged touch screen.

Further, information collected on the mobile data collection units is transmitted, for example via 802.11b wireless LAN, to an SQL Server back office operation. Data is instantly available for near real-time tracking of processes and inventory and for reporting via a desktop computer application or a website interface layer.

One exemplary embodiment of an inventory tracking system in accordance with the present invention tracks the receipt, assessment, repair, storage and shipment of metal containers in a manufacturing plant. In accordance with this embodiment, a secure web-accessible container search/repair approval tool is available to a customer.

With an SQL Server backend, personnel can run a customized desktop computer application, which provides an interface for scheduling loads, building optimized shipments from multiple loads, and cataloging returned goods.

Another particular exemplary embodiment in accordance with the present invention is a method for shipping and tracking goods that comprises loading input data into a system computer, generating a load data packet based on the loaded input data and processing the load packet data in the system computer to generate a shipment data packet, wherein the processing of the load data packet comprises one or more of evaluation of historical pick-up data with respect to a customer, evaluation of a customer relationship, evaluation of a status of outbound shipments and evaluation of a status of inbound shipments.

As used herein “substantially”, “generally”, and other words of degree, are used as a relative modifier intended to indicate permissible variation from the characteristic so modified. It is not intended to be limited to the absolute value or characteristic which it modifies but rather approaching or approximating such a physical or functional characteristic.

### BRIEF DESCRIPTION OF THE DRAWINGS

The aspects of the present invention will become more readily apparent by describing in detail illustrative, non-limiting embodiments thereof with reference to the accompanying drawings, in which:

FIG. 1 is an overall block diagram of a system in accordance with the invention.

FIG. 2 is a block diagram of a loading portion of the overall system of FIG. 1, in accordance with the invention.

FIG. 3 is a block diagram of an enroute portion of the overall system of FIG. 1, in accordance with the invention.

FIG. 4 is a block diagram of an unloading portion of the overall system of FIG. 1, in accordance with the invention.

FIG. 5 is a block diagram of a warehousing portion of the overall system of FIG. 1, in accordance with the invention.

FIG. 6 is a block diagram of a delivery and repair process for collected reusable shipping equipment in accordance with the invention.

### DETAILED DESCRIPTION OF ILLUSTRATIVE, NON-LIMITING EMBODIMENTS

Exemplary, non-limiting, embodiments of the present invention are discussed in detail below. While specific configurations are discussed to provide a clear understanding, it should be understood that the disclosed configurations are provided for illustration purposes only. A person skilled in the relevant art will recognize that other configurations may be used without departing from the spirit and scope of the invention.

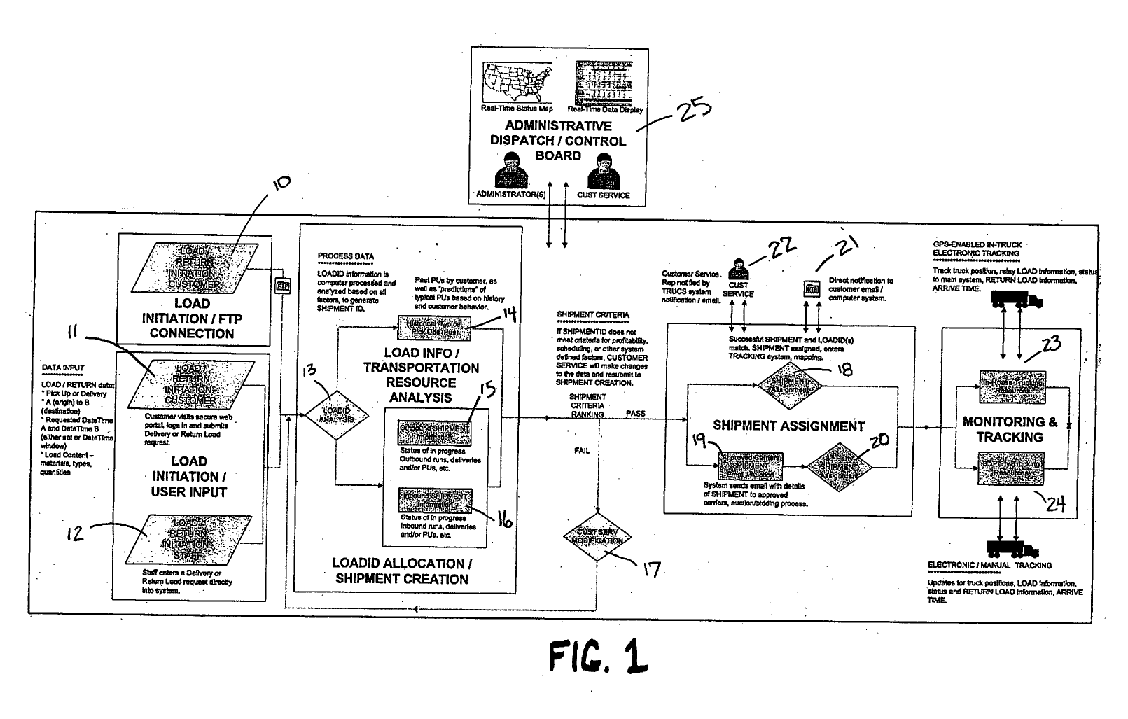

FIG. 1 is an overall block diagram of a transportation resource utilization and control system is accordance with the present invention. For example, the exemplary system illustrated in FIG. 1 may be utilized by a customer to order goods to be shipped from an original location to a final destination. The system can also be utilized to schedule, track and monitor the status of the shipment as well as schedule, track and monitor returned material, such as shipment containers for accepted goods and/or unaccepted goods.

As shown in FIG. 1, a customer initiates a delivery and/or return request by entering data either through an ftp (file transfer protocol) connection (10) or by accessing and logging into a secure website (11). Alternatively, if desired and when the situation warrants, an agent of the supplier initiates the delivery or return request by inputting data directly into the system (12).

The data entered into the system either by the customer or by the supplier's agent might include, for example, identification whether the event is a pick-up or a delivery, e.g., whether the customer has something for the supplier to pick-up at the customer's designated location, or whether the customer wishes the supplier to deliver a particular item to the customer's designated location. Other data entered into the system might include particular dates and times, or ranges of dates and times, the customer desires the pick-up or delivery to occur as well as identification of the specific item(s) desired for pick-up and/or delivery. The specific data mentioned here is exemplary only and a person of ordinary skill would understand that other specific data items could also be entered into the system at this time without departing from the spirit and scope of the invention.

After data such as that which was mentioned above has been entered into the system, a LOADID is created. A LOADID is a compilation of all data relevant to a corresponding shipment. The LOADID is then analyzed by being processed in a computer (13) to generate a SHIPMENTID. For example, in the generation of a SHIPMENTID, the delivery and/or return request data is processed in conjunction with historical data (14), outbound shipment data (15) and inbound shipment data (16). Historical data comprises, for example, data related to the customer's past pick-up orders as well as the customer's history and behavior. For instance, a particular customer might regularly order a pick-up or delivery on an urgent basis, that is, with a very short date and/or time requirement. However, if the customer “regularly” makes such orders, this information can be used in the analysis to plan for such a pick-up or delivery.

The SHIPMENTID includes an optimized schedule and route for a carrier to adopt in carrying out the respective pick-up and/or delivery. The SHIPMENTID is evaluated to determine whether or not the proposed schedule and route meet profitability criteria or other scheduling or system defined factors. If the proposed schedule or route does not meet, or “fails”, these criteria, the LOADID is modified, for example, by the intervention of a customer service representative (17), and the modified LOADID is presented again for LOADID processing by the system computer (13).

If the SHIPMENTID is analyzed and found to meet, or “pass”, the profitability, etc., criteria, the SHIPMENTID is provided to a shipment assignment process. In the shipment assignment process the specified shipment, i.e., the SHIPMENTID, is either assigned directly to a particular shipper (18), e.g., within the direct employ of the supplier, or the SHIPMENTID is passed along to one or more outside shippers approved by the supplier (19). The SHIPMENTID is provided to the approved outside shipper(s) by one or more of a variety of methods, for example, via e-mail or other Internet means, etc. In addition, if the SHIPMENTID is provided to more than one approved shipper, an auction or other type of bidding system may be utilized to determine which one of the approved shippers will ultimately be assigned the shipment. Once the particular approved carrier, i.e., third-party shipper, is selected for the shipment, the particular shipment (SHIPMENTID) is assigned to this carrier (20).

Subsequently, that is after the shipment (SHIPMENTID) has been completely assigned to a particular shipper, e.g., with a specified schedule and route, the customer is notified of the details of the assignment (21). For example, the customer is notified via the FTP interface, e-mail, etc. In particular, a match between the SHIPMENTID and a respective LOADID of a particular customer is sought. If a successful match is found, the SHIPMENTID is entered into the tracking system. In addition to the customer being notified, a customer service representative is also notified automatically via an electronic notification means, such as via e-mail (22).

Once the particular shipment has been assigned to a carrier, the shipment is forwarded to a monitoring and tracking system that monitors the status and location of the specific shipment from the point of origin to the destination point. For example, if the shipment is being shipped via an in-house truck (23), the location of the shipment is monitored via a GPS (global positioning satellite) system installed in the particular truck. If, on the other hand, the shipment is being shipped via a third-party shipper (24), the location of the shipment is tracked using periodic updates to an electronic database. For example, the particular trucker can manually enter location data into a handheld computing device which, in turn, uploads the data to the supplier's system. Alternatively, the third-party vehicle could also be equipped with a GPS system which could automatically update a database accessible by the supplier's system or provide the trucker with specific location data that the trucker can then manually enter into the system.

Regardless of whether the shipment is shipped via in-house resources (23) or third-party resources (24), however, the shipper provides additional data to location data in order to monitor the status, e.g., physical condition, of the shipment. For example, the electronic data sent from the shipper, e.g., truck, includes LOAD and/or RETURN LOAD information identifying the particular goods included in the shipment to the customer or returned goods being returned to the supplier, respectively. Further, the additional information provided includes an ARRIVE TIME which indicates the estimated time that the shipment will arrive at the final destination.

Also, it should be noted that all during the processes described above with respect to shipment initiation through shipment delivery, the data corresponding to the shipment can be monitored and/or modified via an administrative dispatch and control board (25). For instance, one or more shipments can be tracked and monitored in real-time by personnel, e.g., administrators or customer service representatives. Accordingly, if any problems occur with respect to any shipment, for example, a truck breaks down while enroute with a shipment, an alternative SHIPMENTID can be generated, or the original one modified, such that minimal time is lost due to the problem.

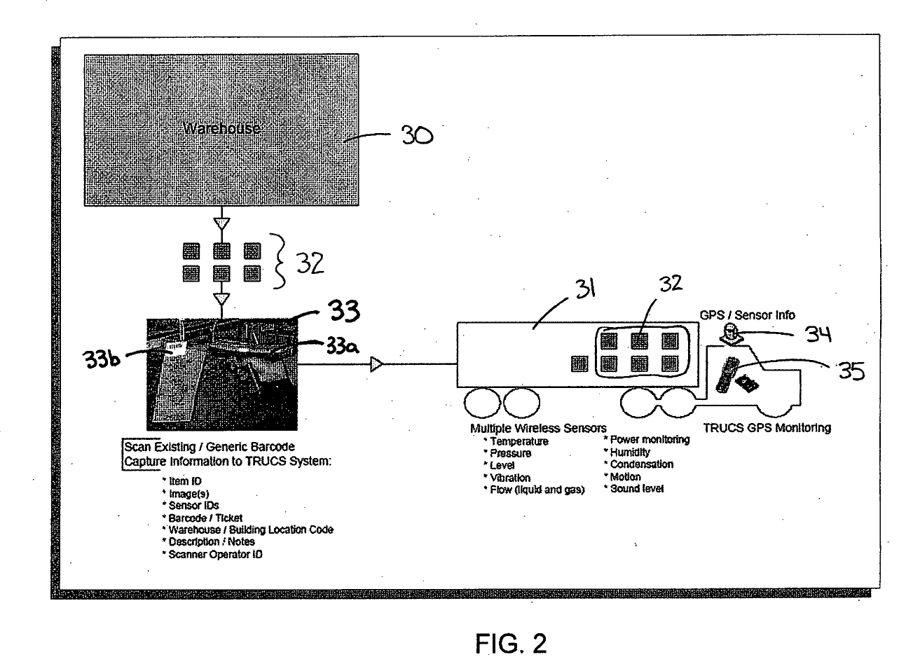

FIG. 2 illustrates an exemplary embodiment of the invention with respect to a loading process that occurs, for example, at the supplier warehouse. In particular, a warehouse (30) stores goods to be shipped pursuant to the shipping process disclosed above with respect to FIG. 1. After the load for the shipment is identified (LOADID), a shipment identification (SHIPMENTID) has been generated, and the shipment has been assigned to a particular carrier, for example an in-house truck (31) as shown in FIG. 2, the shipment (32) is removed from the warehouse (30) and scanned (33) using, for example, a handheld data collection device (33a). The handheld data collection device can be any suitable mobile unit, such as the Dolphin® 9500 barcode reader, manufactured by Hand Held™ Products, Inc. of Skaneateles Falls, N.Y.

According to one embodiment, data collection device (33a) scans a barcode label (33b) attached to each of one or more objects related to a particular shipment (32). By scanning the label particular details related to the shipment are automatically collected and either stored within the data collection device (33a) and/or directly outputted, e.g., wirelessly, to a supervisory database (not shown). Further, the scanning of the label (33b) can be performed via RF (radio frequency) technology by placing the data collection unit (33a) in the proximity of the label (33b) or the data can be collected by physically contacting the collection unit (33a) to the label (33b).

Regardless of the particular mechanism by which the data is gathered, the data collected includes, for example, one or more of, an item identification; digital images of the goods themselves or portions of the goods; data from any specified sensors, such as, temperature sensors, vibration sensors, humidity sensors, etc.; a barcode ticket; a warehouse or building location code; a description of the goods and/or notes pertaining the goods or special instructions for handling, etc.; and a scanner and/or operator identification code.

After the shipment data is gathered by the data collection device (33), the shipment is loaded onto the truck (31), or other vehicle, such as a train, plane, boat, etc., for shipment to the specified destination. Within the truck 31 various sensors, such as one or more of temperature, pressure, level, vibration, flow, humidity, power monitoring, condensation, motion and sound level, sensors can be installed to continuously or on-demand, upload the sensor data via the GPS unit (34). The sensor data can be automatically uploaded from the sensors to the GPS unit or it can be scanned by a handheld device (35). The GPS device, in addition to uploading the sensor data also uploads location tracking data indicating the exact location of the truck, or other vehicle, as well as the shipment carried within.

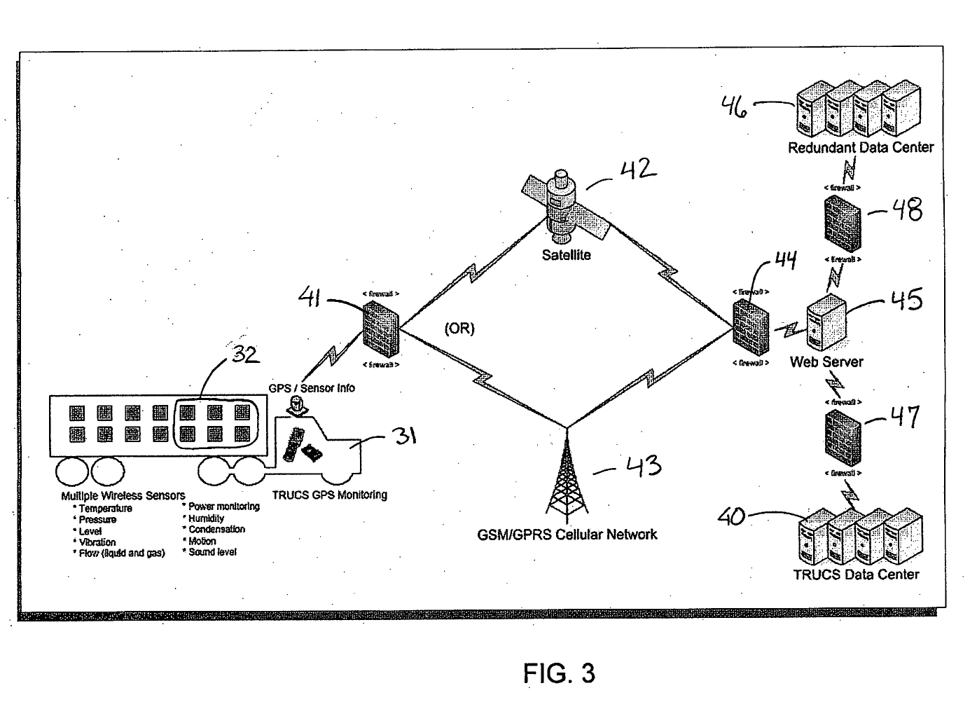

FIG. 3 illustrates an exemplary embodiment of the invention with respect to the actual shipping process as the truck, or other vehicle, is physically enroute from the origin location to the destination location. As shown, truck (31) with shipment (32) aboard uploads the data from the sensors, as discussed above with respect to FIG. 2, to a data center (40) in real-time. More particularly, while enroute, truck (31), using GPS unit (34), transmits sensor and location data through a first firewall (41) to either a satellite (42) or a GSM/GPRS cellular network (43). The data is transmitted from the satellite or GSM/GPRS cellular network (43) through another firewall (44) to a web server (45). Thereafter, the data is sent to the data center (40) and an optional redundant data center (46) through respective corresponding firewalls (47, 48).

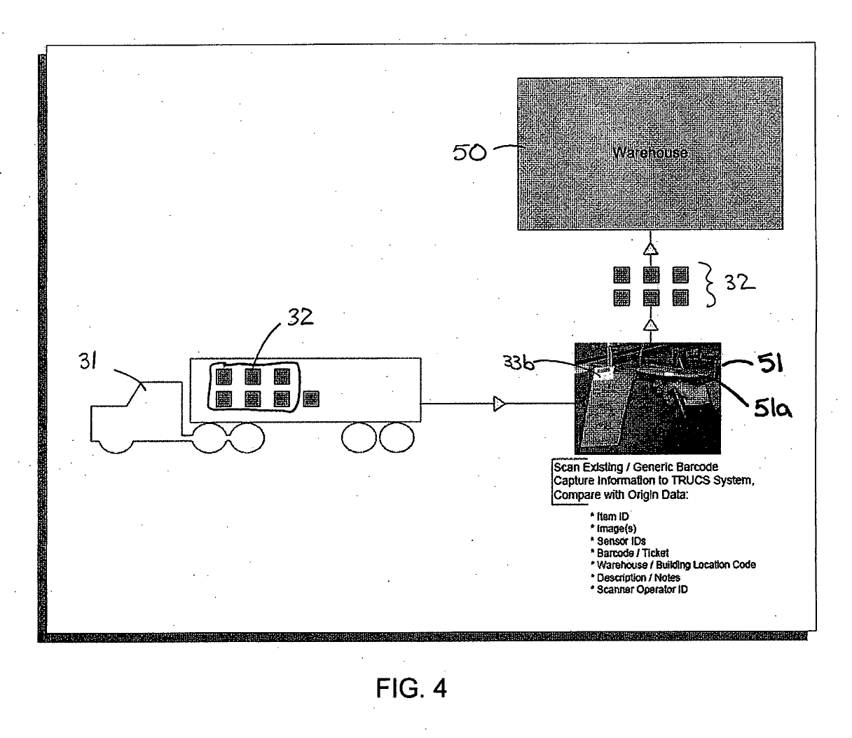

FIG. 4 illustrates an exemplary embodiment of the invention with respect to an unloading process that occurs, for example, at the customer warehouse. In particular, a warehouse (50) receives and stores goods shipped pursuant to the shipping process disclosed above with respect to FIGS. 1 and 2. Once the shipment has reached its final destination, e.g., on truck (31), the shipment (32) corresponding to the original LOADID is removed from the truck 31 and scanned (51) using, for example, a handheld data collection device (51a) similar to the handheld device disclosed with respect to FIG. 2. The label (33b) is scanned to ensure delivery of the specified shipment and to evaluate whether the shipment is in an acceptable condition as compared to the condition it was when it left the supplier's location.

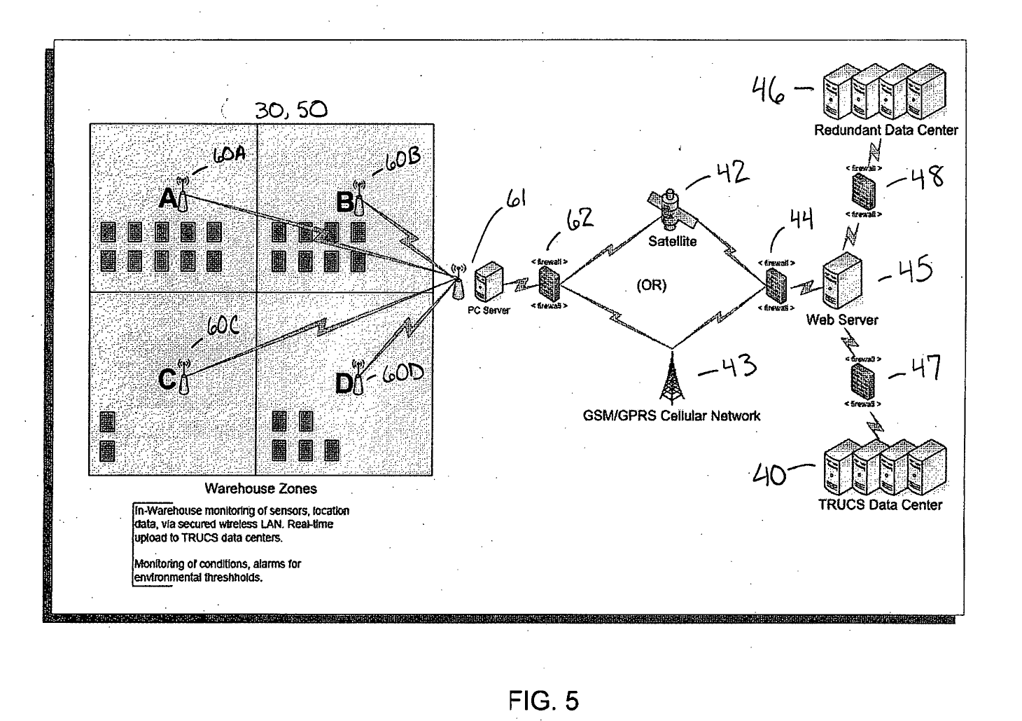

FIG. 5 illustrates an exemplary embodiment of the invention with respect to a warehouse storage process that occurs, for example, at either or both of the customer's or supplier's warehouses. In particular, FIG. 5 illustrates a data collection process that occurs while a warehouse (30, 50) stores goods or containers to be shipped or goods or containers that have already been shipped, pursuant to the shipping process disclosed above with respect to FIGS. 1 and 2. The warehouse is divided into warehouse zones (A-D) that each includes a wireless transponder (60A-60D). Wireless transponders (60A-60D) each continuously monitor data received from the goods stored within their respective zone. For example, the goods stored can include or otherwise be associated with an RF tag that periodically transmits data to the wireless transponder. The wireless transponders then transmit the data to a PC server (61) that is connected to a receiver for receiving the data from the transponders. The PC server (61) then transmits the data corresponding to the stored goods through a firewall (62) and on to the data center (40) and redundant data center (46) in the same manner as data was sent to these data centers from the truck (31) with respect to FIG. 3.

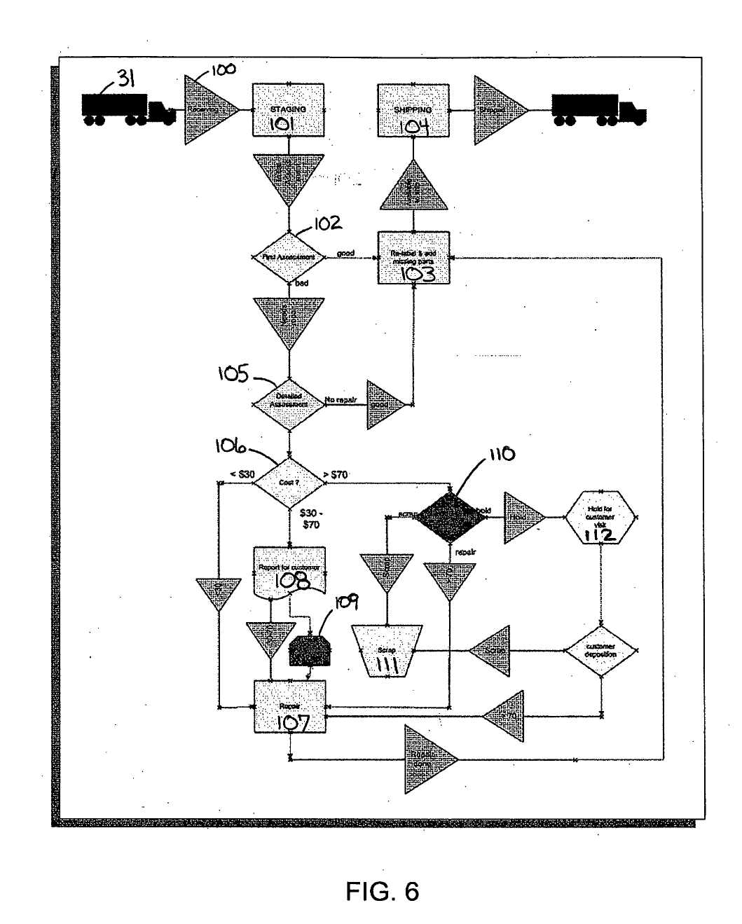

FIG. 6 illustrates an exemplary embodiment of the invention in which racks used in connection with shipping of certain larger goods are returned from a customer. For example, these racks would be returned pursuant to a “return” request as described above with respect to FIG. 1. For example, racks are returned to the supplier after delivery of a particular shipment and the returned racks are either used “as is” for subsequent shipping, repaired and then reused for subsequent shipping, or scrapped.

Referring to FIG. 6, after truck (31) picks up a rack from supplier's facility, i.e., pursuant to a “return” request made via the FTP connection or the secure web server, the rack is delivered to a staging area (101) via the receiving department (100) in supplier's facility or warehouse. An initial assessment (102) is made with respect to the rack as to whether or not the rack needs any repair or whether it is viable for further immediate use in its present condition, e.g., “as is”. If the initial assessment results in a determination that the rack is “good”, that is, it is viable in its present condition, the rack is relabeled (103), e.g., with a new label similar to the label (33b) discussed above with respect to FIGS. 2 and 4. The new label, however, contains data for a new shipment to be shipped on or in the rack. In addition to the rack being relabeled, if any parts of the rack are missing, or otherwise need to be added to the rack, these parts are added and the rack is again available to be used for shipping via the shipping department (104).

If, on the other hand, the initial assessment of the rack results in a determination that the rack is “bad” or, in other words, needs repair, a more detailed assessment (105) is performed. If, as a result of the more detailed assessment, the rack is determined to be “good” and no repair is needed, the rack is relabeled and any missing parts are added (103). The rack is then reused as discussed above.

If the detailed assessment of the rack results in a determination that repairs are, in fact, necessary, a cost associated with the repair is determined (106). If the cost of the repair is below a lower threshold, for example $30, the repairs are made (107) and the rack is relabeled and reused (103) as discussed previously. If the cost of the repair is between the lower threshold and an upper threshold, for example, $70, a report for the customer is generated (108) and the rack is repaired (107) and then relabeled (103) and reused, as discussed above. Optionally, after the report is generated for the customer (108), approval for the repair work can be implemented via the website (109).

Finally, if the cost of the repair work exceeds the upper threshold, website approval for the repair (110) is required. In accordance with the website approval (110), three potential actions can be taken. First, it may be determined that the repair work should be performed regardless of the cost. In this case, the repair work is performed (107) and the rack is relabeled and reused as discussed above. Second, it may be determined that the repair should not be performed under any circumstances. Under this scenario the rack is scrapped (111). Last, it may be determined that the rack should be held in order for a customer visit to be conducted (112). For instance, the customer may wish to personally inspect the rack. Under these conditions, the customer may ultimately decide to scrap the rack (111) or it may decide to perform the needed repair work (107). If the repair work is performed, the rack is then relabeled (103) and reused as discussed above.

While various aspects of the present invention have been particularly shown and described with reference to the exemplary, non-limiting, embodiments above, it will be understood by those skilled in the art that various additional aspects and embodiments may be contemplated without departing from the spirit and scope of the present invention.

Other aspects, objects and advantages of the present invention can be obtained from a study of the drawings, the disclosure and the appended claims.

What is claimed is:

1. A method for shipping and tracking goods, the method comprising:
loading input data into a system computer;
generating a load data packet based on the loaded input data; and
processing the load packet data in the system computer to generate a shipment data packet, wherein said processing comprises one or more of evaluation of historical pick-up data with respect to a customer, evaluation of a customer relationship, evaluation of a status of outbound shipments and evaluation of a status of inbound shipments.

2. A method of shipping and tracking goods as recited in claim 1, wherein the loaded input data comprises one or more of identification whether the shipment is a pick-up or a delivery and a requested date or time for the pick-up or delivery.

3. A method of shipping and tracking goods as recited in claim 1, wherein said loading input data further comprises one or more of, initiating a file transfer protocol (FTP) connection between the customer and a supplier, the customer logging into a secure website managed by the supplier and the supplier directly inputting the input data into the system computer.

4. A method of shipping and tracking goods as recited in claim 1, wherein the shipment data packet comprises a proposed schedule and route for shipping the goods.

5. A method of shipping and tracking goods as recited in claim 4, further comprising:
determining whether the shipment data packet includes data that meets profitability criteria; and
if the shipment data packet includes data that does not meet profitability criteria, reprocessing the load packet data in the system computer to generate a new shipment data packet; or
if the shipment data packet includes data that does meet profitability criteria, assigning a shipment defined by the shipment data packet to a particular shipper.

6. A method of shipping and tracking goods as recited in claim 5, wherein said assigning a shipment to a particular carrier comprises selecting an approved third-party carrier other than a carrier continuously and directly employed by either the supplier or the customer.

7. A system for tracking and monitoring goods, the system comprising:
a computing device operable to continuously collect, store and process data corresponding to the goods throughout an entire cycle with respect to the goods, the cycle comprising one or more of, storing the goods in a warehouse, ordering of the goods by a customer, assignment of the goods to a shipper, loading of the goods to the shipper, transportation of the goods, delivery of the goods and repair of the goods;
one or more mobile data collection devices operable to collect and transmit the data corresponding to the goods at any time during the cycle to said computing device.

8. The system recited in claim 7, wherein the computing device includes one or more of an SQL Server based computer and an Internet Information Server (IIS) that provides a web-accessible interface to said computing device.

9. The system recited in claim 7, wherein the one or more mobile data collection devices are operable to perform one or more of, scanning one and two-dimensional barcodes, scanning a signature and capturing a digital image of the goods.

10. The system as recited in claim 9, wherein said one or more mobile data collection devices is operable to transmit data to said computing device via one or more of, an IEEE 802.11 wireless interface and a Bluetooth wireless interface.
